(19) United States
(12) Patent Application Publication
(10) Pub. No.: US 2026/0328689 A1
(43) Pub. Date: Oct. 22, 2026

(54) METHOD FOR ASCERTAINING THE QUALITY OF A PRODUCT PACKAGE

(71) Applicant: SIROPACK ITALIA S.R.L., Cesenatico (IT)

(72) Inventor: Rocco DE LUCIA, Cesenatico (IT)

(73) Assignee: SIROPACK ITALIA S.R.L., Cesenatico, FC (IT)

(21) Appl. No.: 19/157,515

(22) PCT Filed: Apr. 4, 2024
(86) PCT No.: PCT/EP2024/059212

§ 371 Date: Aug. 18, 2025

(30) Foreign Application Priority Data
Apr. 6, 2023 (IT) 102023000006810

(51) Int. Cl. G01N 21/64; B65B 7/28; B65B 51/02; B65B 57/02; B65B 61/26; G06K 7/10; G06K 7/14; G06T 7/00

(52) U.S. Cl. CPC G01N 21/6456; B65B 7/2871; B65B 51/026; B65B 57/02; B65B 61/26; G01N 21/6428; G06K 7/10722; G06K 7/1417; G06T 7/001; G01N 2021/6439; G06T 2207/30128

(57) ABSTRACT

A method for ascertaining the quality of a package of a product, the package including a tray sealed by a film, and, during the product packaging the package is sealed by glueing the film on an upper peripheral edge of the tray by a glue layer, a label having a QR code including a URL and a unique code associated with the package is applied on the film, an image of the package is acquired to verify continuity and integrity of the bonding of the film on the upper peripheral edge, and if the verification of the bonding is successful, the acquired image is stored in a database by associating the image with the unique code; and a smartphone scans the label to extract the unique code and URL, connects to the server to and displays the image to allow the final consumer to ascertain the quality of the package.

### TECHNICAL FIELD

The present invention relates to a method for ascertaining the quality of a package of a product, and in particular a food product packaged in a polymer container.

### BACKGROUND

In the field of packing food products in related containers, it is known to make a machine of the type comprising an input station adapted to receive a succession of trays, each of which is made of a polymeric material, is delimited by a bottom wall and by a side wall and has an upper peripheral edge provided with a layer of non-stick material, a removal station for removing the layer of non-stick material from the upper peripheral edge, a glue application station for applying a layer of glue directly on the polymeric material of the upper peripheral edge, a filling station for feeding at least one food product into the tray, and a sealing station for gluing a sealing film on the upper peripheral edge and for sealing the related container.

The machine of the above-described type moreover comprises a control station, which is arranged between the glue application station and the filling station and is provided with a video camera to control continuity and integrity of the layer of glue applied on the upper peripheral edge.

Although highly tested, the machine of the above-described type is however unable to control the correct gluing of the sealing film on the outer peripheral edge and thus the correct sealing of the container. Moreover, the final consumer cannot verify whether any gluing defect of the purchased package is due to the packaging machine or has been originated in the distribution chain downstream of the packaging.

### SUMMARY

An object of the present invention is to provide a method that allows the final consumer to ascertain the quality of a package of a food product, said method overcoming the above-described drawbacks and, meanwhile, being simple and of economical implementation.

According to the present invention a method is provided for ascertaining the quality of a package of a product according to what is claimed in the appended claims.

According to a further aspect of the present invention, the method allows the final consumer to check if the sealing film has been glued to the upper peripheral edge of the container.

The claims describe preferred embodiments of the present invention to be considered as an integral part of the present description.

### BRIEF DESCRIPTION OF THE DRAWINGS

The present invention will be now described with reference to the enclosed drawings, which illustrate a non-limiting embodiment, wherein:

FIGS. 1a to 1h schematically illustrate, in a side top view and with parts removed for the sake of clarity, a preferred embodiment of a packaging machine that implements some steps of the method of the present invention;

FIGS. 2 and 3 are two schematic plan views, with parts removed for the sake of clarity, of two details of the machine of FIG. 1;

FIGS. 4 to 7 schematically illustrate in perspective view respective production steps of the container through the machine of FIGS. 1, 2, and 3;

FIG. 8 illustrates a further step of the method of the present invention;

FIG. 9 shows a plan view of a container before gluing the sealing film;

FIG. 10 schematically shows a side top view of a container before gluing the sealing film;

FIG. 10a schematically shows a side top view of a detail of the edge of the container shown in FIG. 10;

FIG. 11 schematically shows a plan view of the edge of the container shown in FIG. 10;

FIG. 11a schematically shows a plan view of a detail of the container shown in FIG. 11;

FIG. 12 shows a plan view of a container after gluing the sealing film;

FIG. 13 schematically shows a side top view of the container after gluing the sealing film;

FIG. 13a schematically shows a side top view of a detail of the edge of the container shown in FIG. 13;

FIG. 14 schematically shows a plan view of the edge of the container shown in FIG. 13; and

FIG. 14a schematically shows a plan view of a detail of the container shown in FIG. 13.

### DESCRIPTION OF EMBODIMENTS

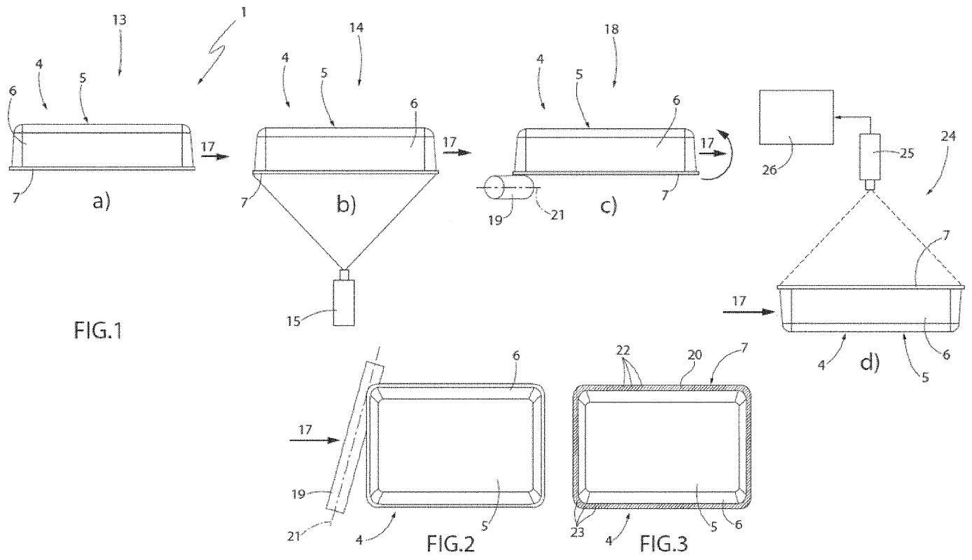

With refence to FIGS. 1 to 7, reference number 1 globally indicates a machine for packing products 2, and in particular food products, in related containers 3. The container 3, which is globally illustrated by FIG. 4, represents the package of the product 2 which will be marketed and for this reason the container 3 will also be called hereinafter with the term “package”.

Each container 3 comprises a tray 4 of polymeric material and is cup-shaped for housing at least one food product 2 therein, is delimited by a bottom wall 5 and is further delimited by a ring-closed side wall 6 about the wall 5 itself.

The tray 4 has an upper peripheral edge 7 substantially plane, which is obtained along the wall 6 and is sealed, once the food product 2 has been inserted, by a sealing film 8, preferably made in a transparent material, glued along the edge 7 itself.

The tray 4 is made from a sheet 9, which is separated by a tape 10 delimited by two faces 11a and 11b opposite each other and is unwound from a coil 12.

To prevent the layers of tape 10 wound on the coil 12 from adhering to each other, the tape 10 is provided with a layer of non-stick material (not shown) applied on a face 11a.

When the tape 10 is wound on the coil 12, the layer of non-stick material (not shown) applied on the face 11a comes into contact with the other face 11b and is transferred at least in part onto the face 11b itself.

The machine 1 comprises an input station 13 adapted to receive in input a succession of trays 4 coming from a stack (not shown) of trays 4 or from a forming machine (not shown) of the trays 4 themselves.

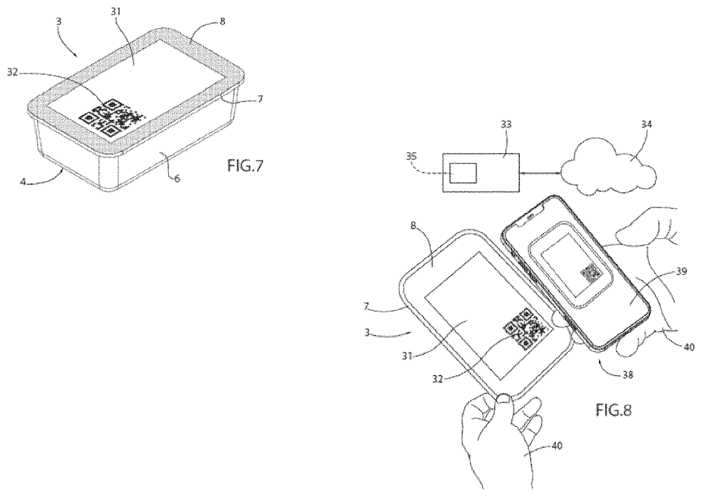

Each tray 4 is fed, specifically with its concavity facing downwards, through a removal station 14 provided with a laser device 15 configured to remove a layer 16 of non-stick material (FIG. 6) present on the edge 7.

According to an embodiment not shown, the layer 16 present on the edge 7 is removed through a chip extraction machining, for example a grinding treatment performed by a grinding roller mounted to rotate about a rotation axis transversal to a feeding direction 17 of the tray 4.

In this regard, it is worth specifying that the edge 7 is quadrilateral-shaped and comprises two longitudinal portions substantially parallel to the direction 17 and two transversal portions substantially transversal to the direction 17 itself (FIG. 6).

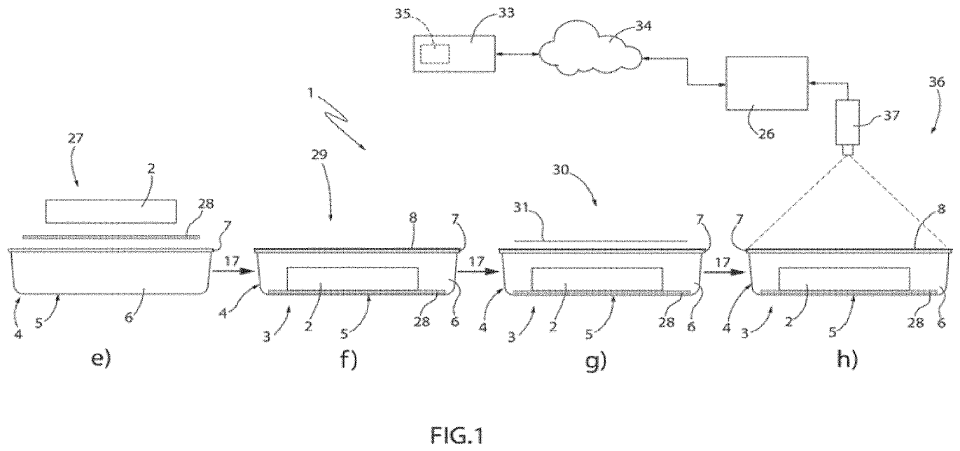

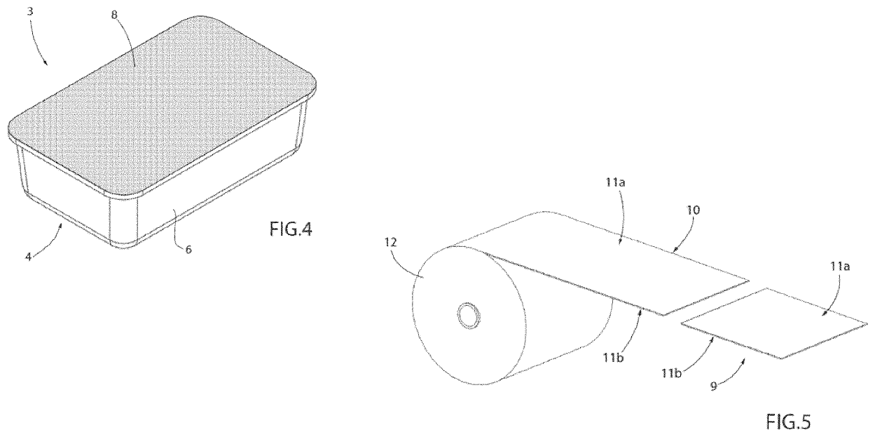

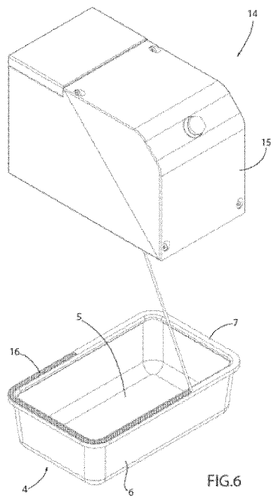

Once the layer 16 has been removed, the tray 4 is fed in the direction 17 through a glue application station 18 provided with an applicator roller 19 adapted to apply a glue layer 20 (FIG. 3) directly onto the polymeric material of the edge 7 and without the interposition of the layer 16 itself.

The roller 19 is mounted below the tray 4 to rotate about a rotation axis 21, which extends parallel to a containment plane of the edge 7 and is tilted according to an angle other than 90° relative to the direction 17.

Regarding the above, it is worth specifying that: the layer 20 is applied along the entire edge 7 and onto at least part of the width thereof; the layer 20 applied by the roller 19 on the edge 7, due to the intrinsic characteristics of the roller 19, has a non-uniform thickness and an alternation of glue areas 22 of greater thickness and glue areas 23 of thinner thickness; and the areas 22 and 23 are substantially transversal to the axis 21 and oriented according to an angle other than 0° relative to the direction 17.

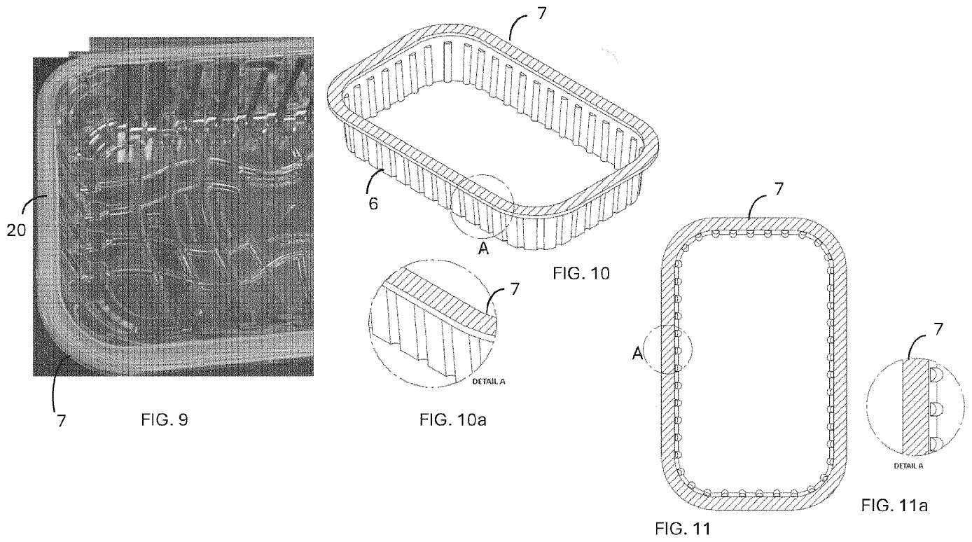

As also shown in FIGS. 9-11a, it is possible to see the glue layer 20 on the upper peripheral edge 7 which has a distribution along the entire edge 7 itself. The entire edge 7 is covered with the glue layer 20, according to the distribution already disclosed above.

Afterwards, the tray 4 is rotated with its concavity facing upwards and fed through a first control station 24 provided with a video camera 25 to acquire a further image which is a plan image of the tray 4 which is used by a control unit 26 of the machine 1 to check the integrity and correct application of the glue layer 20 on the edge 7.

The further image can also be an image already available for a general tray and not necessarily an image taken for the tray 4.

If the image acquired by the video camera 25 shows, parallel to the direction 17, an alternation of areas 22 and areas 23, the layer 20 has been applied correctly by the roller 19 on the edge 7 and the tray 4 passes the check of the control unit 26 without being discarded.

In this regard, it is worth specifying that the control station 24 is further provided with a first discard device (not shown) controlled by the control unit 31 for discarding trays 4 in response to an image which does not show an alternation of areas 22 and areas 23 parallel to the direction 17.

At this point, the tray 4 is fed, in the following order, through a filling station 27, at which the tray 4 receives a sheet 28 of absorbent paper and at least one food product 2, through a sealing station 29, at which the tray 4 is sealed by fixing the related sealing film 8 on the edge 7 through the glue layer 20, and through a labeling station 30, at which a label 31 is applied onto the film 8.

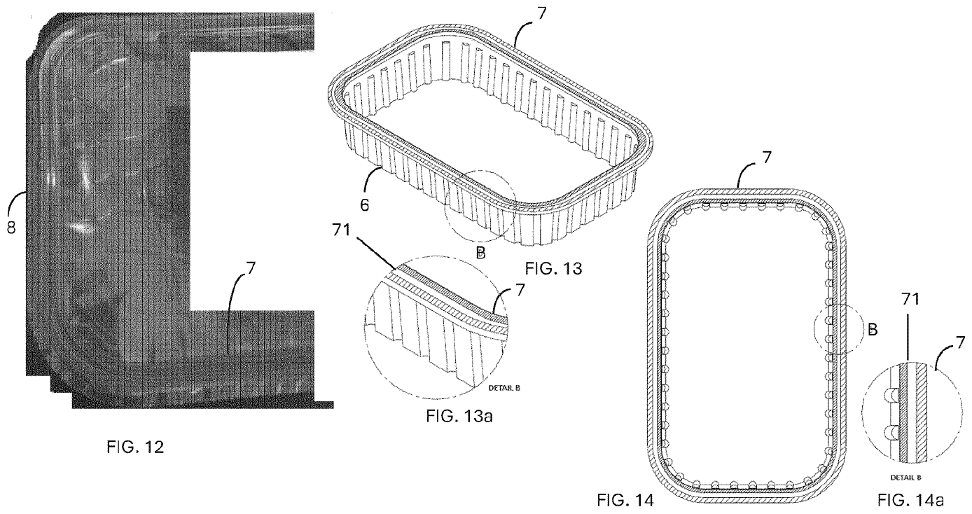

With particular reference to FIGS. 12-14a, after applying the sealing film 8 on the edge 7, the glue layer 20 changes its shape, with respect to the distribution of the glue layer 20, shown in the FIGS. 9-11a, previously analyzed.

The glue layer 20 changes its shape and distribution on the edge 7, as it moves towards the boundaries of the edge 7, leaving a central portion 71, where the sealing film 8 is bonded with the edge 7, along the entire edge 7.

If the central portion 71 is a continuous line along the entire edge 7, it means that a change in the distribution of the glue layer 20 occurred, with respect to the distribution of the glue layer 20 before sealing the sealing film 8, hence the sealing film 8 is bonded with the edge 7.

With particular reference to FIG. 7, the label 31 comprises a QR code 32 including a URL for access a server 33 and a unique code associated with the container 3, i.e. with the package of the product 2. The server 33 is a remote server, which communicates with the control unit 26 via the internet 34. On the server 33 a database 35 for storing images of the container 3 is installed, as it will be explained more in detail hereinafter.

According to a further embodiment not shown, the server 33 is part of the machine 1, is connected to the control unit 26 via a local network and communicates with the Internet 34.

Finally, the sealed and newly labelled container 3 is fed through a second control station 36 provided with a video camera 37 to acquire a plan image of the container 3 which is used by the control unit 26 to control continuity and integrity of the bonding of the film 8 along the edge 7. It is noted that the transparent material of the film 8 allows watching the glue layer 20 between the film 8 itself and the edge 7.

At this end, it is necessary that the tray 4 or the sealing 8 be transparent. If the tray 4 is transparent, the sealing film 8 can be coloured. On the contrary, if the tray 4 is coloured, the sealing film 8 can be transparent.

In particular, if the tray 4 is transparent and the sealing film 8 is coloured, it is possible to take an image also from the bottom wall 5 of the tray 4.

If the check is successful, namely if the image acquired by the video camera 37 shows a continuous and integral bonding of the film 8 along the entire edge 7, this means that the container 3 is correctly sealed, and thus is considered suitable for marketing, and the image is stored in the database 35 by associating said image with the unique code included in the QR code 32 on the label 31. In this regard, the control unit 26 is configured to read the QR code 32, and thus to extract the respective unique code, from the image acquired by the video camera 37.

Instead, if the check is not successful, namely if the image acquired by the video camera 37 shows at least one discontinuity in the bonding of the film 8 along the edge 7, this means that the container 3 is not sealed, and thus that the inner video camera of the container 3 communicates with the external environment thus compromising the integrity of the food product 2, and the container 3 is discarded.

In this regard it is worth specifying that the control station 36 is further provided with a second discard device (not shown) to discard the containers 3 in response to an image that shows at least one discontinuity in the bonding of the film 8 along the edge 7.

The double acquisition of the images, by the first video camera 25 and the second video camera 37, allows to compare the area of the edge 7 covered by the glue layer 20, before gluing the sealing film 8 on the edge 7 and after gluing the sealing film 8 on the edge 7. In particular the change of the area of the edge 7 covered by the glue layer 20 occurring after gluing the sealing film 8 on the edge 7 is detected, comparing the pixel of the two images.

If the second image shows a change in the area of the edge 7 covered by the glue layer 20, it means that the sealing film 8 has been glued on the edge 7. Advantageously, the glue layer 20 comprises a luminophore substance activatable by an excitation wavelength band, i.e. a substance capable of emitting visible light at room temperature when excited by the excitation wavelength band. This allows improving the check of the integrity and correct application of the glue layer 20 on the edge 7 performed by the control station 24 and improving the check of continuity and integrity of the bonding of the film 8 on the edge 7. To this end, both video cameras 25 and 37 comprise respective sources emitting radiations in the excitation wavelength band, these sources being hereinafter also called light sources for the sake of simplicity.

In particular, the excitation wavelength band comprises ultraviolet light. In particular, the luminophorous substance emits a radiation in a wavelength band ranging from 250 to 600 nm, i.e. comprising ultraviolet light and visible light. In particular, the glue of the glue layer 20 has a viscosity ranging from 500 mPas to 1600 mPas.

The presence of the luminophore substance in the glue layer 20 increases the quality of the image taken by the first video camera 25 and the image taken by the second video camera 37, allowing the comparison of the area of the edge 7 covered by the glue layer 20 before and after sealing the sealing film 8 on the edge 7.

In fact, as shown in FIG. 9, before gluing the sealing film 8 on the edge 7, this latter looks all fluorescent.

Referring now to the FIG. 12, after gluing the sealing film 8 on the edge 7, the region where the sealing film 8 and the edge 7 are bonded, which is the central portion 71, looks black, meanwhile the glue layer 20 which is in the peripheral boundaries of the edge 7 still looks fluorescent.

The operation of the above-described machine 1 implements a first macro step of the method of the present invention, i.e. a packaging step of the product 2 which comprises the following steps:
applying the glue layer 20 on the edge 7 of the tray 4 where the product 2 is placed;
glueing the film 8 on the upper edge 7 to seal the package 3;
applying the label 31 on the film 8;
through the video camera 37, acquiring an image of the package 3 to check continuity and integrity of the bonding of the film 8 on the edge 7; and
if the check of the bonding is successful, storing the acquired image in the database 35 by associating the image with the unique code read by the label 31.

The method also comprises the step of checking at least once the change of the area of the upper peripheral edge 7 covered by the glue layer 20 after gluing the sealing film 8 on the upper peripheral edge 7, with respect to the area of the edge 7 covered by the glue layer 20 before gluing the sealing film 8.

As previously stated, the glue layer 20 of glue comprising the luminophorous substance that can be activated by said excitation wavelength band and the video camera 37 acquires the image by illuminating the package 3 via its own light source operating at the excitation wavelength band.

With reference to FIG. 8, the method of the present invention comprises a further macro step, namely a step of ascertaining the integrity of the package by a final consumer, performed through a personal mobile communication device held by the consumer 40, for instance a smartphone 38, which is per se known and comprises a screen 39, at least one rear video camera (not shown), a processor (not shown) and a data transceiver module (not shown) operating on a local wireless network or a mobile network to connect to the server 33 through the internet 34.

In particular, on the smartphone 38 used by the consumer 40 to ascertain the integrity of the package 3, an application (App) designed to implement the following steps, when executed by the processor, is installed:
scanning the label 31 of the package 3 through the video camera to read the QR code 32 in order to extract the unique code and the URL;
connecting to the server 33 through the URL to communicate the unique code to the server 33 and downloading the respective image from the database 35; and
displaying the downloaded image via the screen 39 to allow the consumer 40 to ascertain the quality of the package 3, in particular, to ascertain integrity and continuity of the bonding of the film 8 along the edge 7.

In particular, the consumer 40 ascertains the quality of the package 3 by comparing what he can see of the package 3 in his hand with what he can see from the image related to the same package 3 at the exit of the machine 1. In the image downloaded from the database 35 and displayed on the screen 39, the bonding along the edge 7 is highlighted by the brightness emitted by the luminophorous substance present in the glue layer 20.

The method further comprises the step of acquiring a further image of the tray 4 after applying a glue layer 20 on the upper peripheral edge 7 of the tray 4 in which the product 2 is placed.

The method can further comprise the step of checking in the image of the package 3 the presence of a central portion 71, where the sealing film 8 is bonded with the upper peripheral edge 7, running along the entire upper peripheral edge 7.

The method can further comprise the step of comparing the further image with the image of the package 3, to check the change of the area of the upper peripheral edge 7 covered by the glue layer 20.

Advantageously, in the database 35 additional information associated with the unique code are stored, for instance information of the product 2 which must be clearly written on the label 31 according to the rules that regulate the marketing of the product 2. For instance, if the product is minced meat, this information includes the places of breeding and slaughter of the meat animals, the place of preparation of the minced meat, the net weight, the preparation and expiry dates and the price. The App installed on the smartphone 38 is designed to download the additional information associated with the unique code from the database 35 and to display it on the screen 39 in an orderly manner.

Although the above described invention particularly relates to a very specific exemplifying embodiment, it must not be considered limited to this exemplifying embodiment, all those variations, modifications or simplifications covered by the attached claims, such as for instance the use of the method for packages of any product, even non-food ones (and therefore not requiring any sheet of absorbent paper 28 in the tray 4), and the use of a different personal mobile communication device by the consumer 40, for instance a tablet, falling within the scope of the invention.

From what has been described above, it can be inferred that the main advantage of the above-described method is to allow the final consumer to ascertain the quality of a product package at the time of purchase, quickly and using commonly used means (smartphone or tablet). In particular, the final consumer will be able to realize whether any defect on the package is due to the packaging process or is originated in the distribution chain downstream of the packaging.

1-10. (canceled)

11. A method for ascertaining quality of a package of a product, the package comprising a cup-shaped tray for containing the product and a sealing film applied to an upper peripheral edge of the tray, the method comprising:
a step of packaging the product; and
a step of ascertaining integrity by a final consumer; wherein the step of packaging the product comprises:
applying a glue layer on the upper peripheral edge of the tray in which the product is placed,
gluing the sealing film on the upper peripheral edge to seal the package;
acquiring an image of the package to verify continuity and integrity of the bonding of the sealing film to the upper peripheral edge; and
checking at least once the change of the area of said upper peripheral edge covered by said glue layer after gluing said sealing film on said upper peripheral edge, with respect to the area of said upper peripheral edge covered by said glue layer before gluing said sealing film.

12. The method according to claim 11, further comprising steps of:
applying a label to the sealing film, the label comprising a QR code comprising a URL for access to a server and a unique code associated with the package;
storing the acquired image in a database of the server by associating the image with the unique code, when the check of the bonding is successful; and
the step of ascertaining integrity by a final consumer being performed through a personal mobile communication device, which has a camera and a screen, and comprising:
scanning the label of the package via the camera to read the QR code in order to extract the unique code and URL;
connecting to the server via the URL to communicate the unique code and download the respective image from the database;
displaying the image via the screen to enable the final consumer to ascertain the quality of the package.

13. The method according to claim 11, wherein the glue layer comprises a luminophore substance activatable by an excitation wavelength band and said image being acquired by illuminating the package by a source emitting said excitation wavelengths band.

14. The method according to claim 11, wherein said excitation wavelength band comprises ultraviolet light.

15. The method according to claim 11, wherein said luminophore substance is configured for emitting a radiation in a wavelength band ranging from 250 to 600 nm.

16. The method according to claim 11, wherein the method further comprises a step of acquiring a further image of said tray after the step of applying a glue layer on the upper peripheral edge of the tray in which the product is placed.

17. The method according to claim 11, further comprising a step of checking in said image of the package the presence of a central portion, where said sealing film is bonded with said upper peripheral edge, running along the entire upper peripheral edge.

18. The method according to claim 16, wherein the method further comprises the step of comparing said further image with said image of said package, to check the change of the area of said upper peripheral edge covered by said glue layer.

19. The method according to claim 11, wherein the sealing film used is transparent.

20. The method according to claim 11, wherein the tray used is transparent.
